(19) United States
(12) Patent Application Publication
(10) Pub. No.: US 2024/0061847 A1
(43) Pub. Date: Feb. 22, 2024

(54) SET INTERSECTION APPROXIMATION USING ATTRIBUTE REPRESENTATIONS

(71) Applicant: Microsoft Technology Licensing, LLC, Redmond, WA (US)

(72) Inventor: Jeffrey W. Pasternack, Los Altos Hills, CA (US)

(21) Appl. No.: 17/889,308

(22) Filed: Aug. 16, 2022

(51) Int. Cl. G06F 16/2457; G06F 16/2455; G06N 20/00

(52) U.S. Cl. CPC G06F 16/24578; G06F 16/24558; G06N 20/00

(57) ABSTRACT

Embodiments of the disclosed technologies include generating an approximation of an intersection of attribute sets using set vectors and an inner product of the set vectors. A set of feature values is generated using the approximation. A machine learning model is trained using the set of feature values.

### TECHNICAL FIELD

The present disclosure generally relates to training machine learning models, and more specifically, relates to generating training data for ranking machine learning models.

### BACKGROUND

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system 100 that includes a set intersection approximation component 150 in accordance with some embodiments of the present disclosure.

FIG. 2 is a block diagram of an exemplary computing system 200 that includes a set intersection approximation component 150 in accordance with some embodiments of the present disclosure.

FIG. 3 is a flow diagram of an example method 300 to approximate set intersections using attribute representations in accordance with some embodiments of the present disclosure.

FIG. 4 is a flow diagram of an example method 400 to approximate set intersections using attribute representations in accordance with some embodiments of the present disclosure.

FIG. 5 is a block diagram of an example computer system in which embodiments of the present disclosure can operate.

### DETAILED DESCRIPTION

Aspects of the present disclosure provide set intersection approximation using attribute representations. The disclosed set intersection approximation methods are useful for training and/or operating machine learning models, including machine learning models that are used to rank content items such as search results (“ranking models”).

Machine learning models are based on data sets. In many cases, data sets are processed in order to create the inputs to which a machine learning model is applied. Set intersections and cardinality computations are examples of such processing. For example, machine learning models can use set intersections or the cardinality of the set intersections to determine similarities between different data sets. Also, in response to a search query, set intersections can be used to determine similarities between search results and the search query.

Set intersections are also used to compute pairwise statistics, such as a count of the number of responses to a post made by viewers in a certain geographic location on posts authored by people in a certain industry. Many common questions in data analytics amount to querying the cardinality of a set intersection, for instance: “how many software engineers are there in the UK?” or “do high-volume creators have larger audiences in the US than in other countries?” Calculating the exact set intersection for these and similar types of queries would be computationally expensive and time-consuming (taking time at least linear in size to the union of all sets of interest). The disclosed approximate set intersection techniques can instead execute these types of queries in time linear to the number of sets of interest, which is essentially instantaneously.

A set intersection identifies similarities between separate data sets. For example, each data set may be a vector (“set vector”) that contains multiple data values, and any of those data values may be contained in one or more other data sets. The set intersection is a vector composed of all of the shared values across all of the set vectors (i.e., all of the values that the set vectors have in common).

The traditional way to compute a set intersection is to perform an exact set intersection. Exact set intersection requires the individual elements of the data sets to be compared element by element. As the sizes of data sets used to create and operate machine learning models increase, exact set intersection calculations require increasing amounts of computational power, computational time, and data storage. For example, performing exact set intersection with large data sets requires large amounts of storage for hash tables and long computation times to compare the elements of the sets.

Aspects of the present disclosure address the above and other deficiencies by approximating set intersections using attribute representations. The disclosed approaches generate set intersection approximations that are estimates of set intersections, rather than computing exact set intersections. As such, the disclosed approaches do not require comparing the data sets element by element. The disclosed approaches use attribute representations to generate set intersection approximations. Attribute representations are stored representations of elements of a set, such as vector representations of a value or characteristic.

Approximating set intersections using attribute representations as disclosed herein takes significantly less time and is a significantly more efficient calculation than exact set intersections. Approximating set intersections using attribute representations also requires less storage than calculating an exact set intersection because there is no need to store hash tables while comparing sets. Additionally, the disclosed approaches for approximating set intersections using attribute representations can handle multisets much more efficiently than previous methods that calculate exact set intersections. Multisets are sets in which a particular attribute can have more than one value; e.g., a “skills” attribute of a user profile could have the values of Python, R, and C++. Approximating set intersections using attribute representations can also be used for non-integer attributes in a data set. The use of approximate set intersections to generate feature values for inputs of a machine learning model is one example use case to which this disclosure can be applied. This disclosure is applicable to other use cases in which set intersections are needed or set intersection approximation is desired, including query execution advertisement reach estimation, and data analytics.

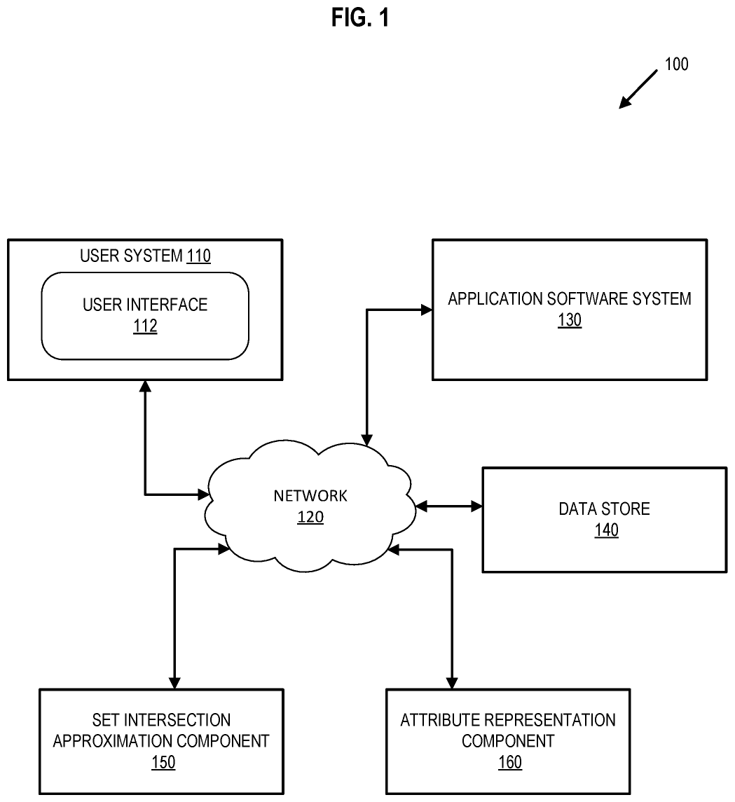

FIG. 1 illustrates an example computing system 100 that includes a set intersection approximation component 150. In the embodiment of FIG. 1, computing system 100 also includes a user system 110, a network 120, an application software system 130, a data store 140, and an attribute representation component 160.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to input search queries and view or otherwise perceive output that includes data produced by application software system 130. For example, user interface 112 can include a graphical user interface and/or a conversational voice/speech interface that includes a mechanism for entering a search query and viewing query results and/or other digital content. Examples of user interface 112 include web browsers, command line interfaces, and mobile apps. User interface 112 as used herein can include application programming interfaces (APIs).

Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Application software system 130 is any type of application software system that includes or utilizes functionality provided by set intersection approximation component 150. Examples of application software system 130 include but are not limited to connections network software, such as social media platforms, and systems that are or are not based on connections network software, such as general-purpose search engines, job search software, recruiter search software, sales assistance software, advertising software, learning and education software, or any combination of any of the foregoing.

While not specifically shown, it should be understood that any of user system 110, application software system 130, data store 140, set intersection approximation component 150, and attribute representation component 160 includes an interface embodied as computer programming code stored in computer memory that when executed causes a computing device to enable bidirectional communication with any other of user system 110, application software system 130, data store 140, set intersection approximation component 150, and attribute representation component 160 using a communicative coupling mechanism. Examples of communicative coupling mechanisms include network interfaces, inter-process communication (IPC) interfaces and application program interfaces (APIs).

A client portion of application software system 130 can operate in user system 110, for example as a plugin or widget in a graphical user interface of a software application or as a web browser executing user interface 112. In an embodiment, a web browser can transmit an HTTP request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

Each of user system 110, application software system 130, data store 140, set intersection approximation component 150, and attribute representation component 160 is implemented using at least one computing device that is communicatively coupled to electronic communications network 120. Any of user system 110, application software system 130, data store 140, set intersection approximation component 150, and attribute representation component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, set intersection approximation component 150, and/or attribute representation component 160. User system 110 is configured to communicate bidirectionally with any of application software system 130, data store 140, set intersection approximation component 150, and/or attribute representation component 160 over network 120.

The features and functionality of user system 110, application software system 130, data store 140, set intersection approximation component 150, and attribute representation component 160 are implemented using computer software, hardware, or software and hardware, and can include combinations of automated functionality, data structures, and digital data, which are represented schematically in the figures. User system 110, application software system 130, data store 140, set intersection approximation component 150, and attribute representation component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

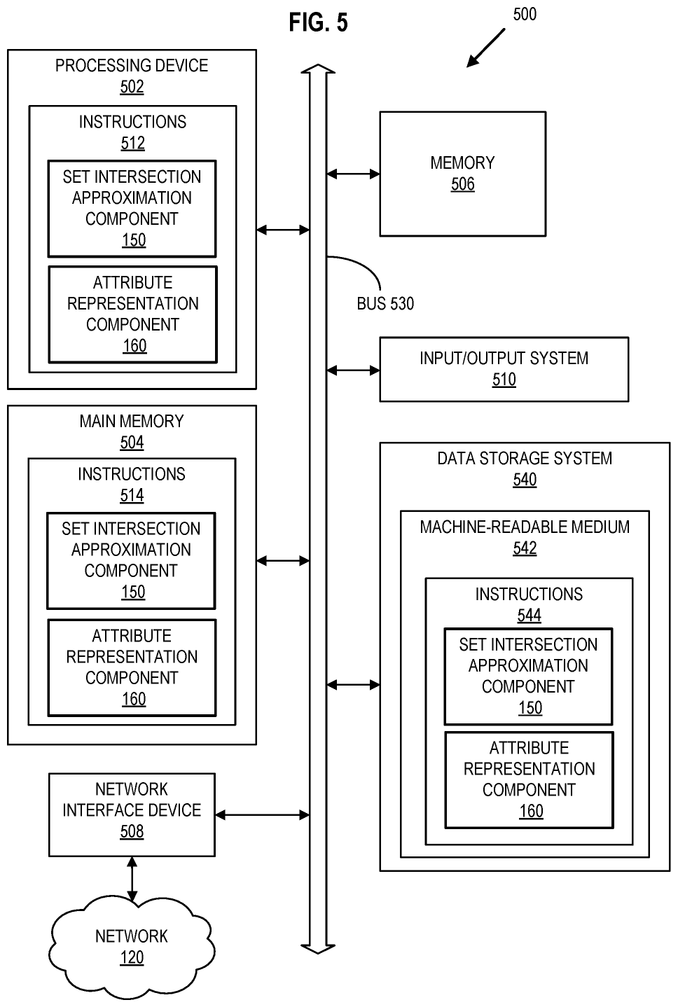

The computing system 110 includes a set intersection approximation component 150 that can approximate set intersections using attribute representations. Set intersection approximations generated by set intersection approximation component 150 can be used to, for example, generate feature values to be used as inputs for a machine learning model. In some embodiments, the application software system 130 includes at least a portion of the set intersection approximation component 150. As shown in FIG. 5, the set intersection approximation component 150 can be implemented as instructions stored in a memory, and a processing device 502 can be configured to execute the instructions stored in the memory to perform the operations described herein.

The disclosed technologies can be described with reference to an example use case of approximating set intersections using attribute representations to generate feature values for a machine learning model used to determine downstream behavior of an application software system. For example, the disclosed technologies can be used to generate training data for a ranking model used by a social graph application such as a professional social network application. The disclosed technologies are not limited to social graph applications or to machine learning model training but can be used to perform set intersection approximation more generally. The disclosed technologies can be used by many different types of network-based applications in which approximating set intersections is useful.

The computing system 110 includes an attribute representation component 160 that can generate attribute representations. In some embodiments, the application software system 130 includes at least a portion of the attribute representation component 160. As shown in FIG. 5, the attribute representation component 160 can be implemented as instructions stored in a memory, and a processing device 502 can be configured to execute the instructions stored in the memory to perform the operations described herein.

The disclosed technologies can be described with reference to an example use case of generating attribute representations for multisets with non-integer attributes. For example, attribute representations generated by attribute representation component 160 can be used to generate training data for a machine learning model used by a social graph application such as a professional social network application. The disclosed technologies are not limited to social graph applications or to training data generation but can be used to perform attribute representation generation more generally. The disclosed technologies can be used by many different types of network-based applications in which attribute representations are useful. For example, the disclosed technologies can be used when representing attributes for data sets to generate feature values for machine learning model inputs.

Further details with regard to the operations of the set intersection approximation component 150 and the attribute representation component 160 are described below.

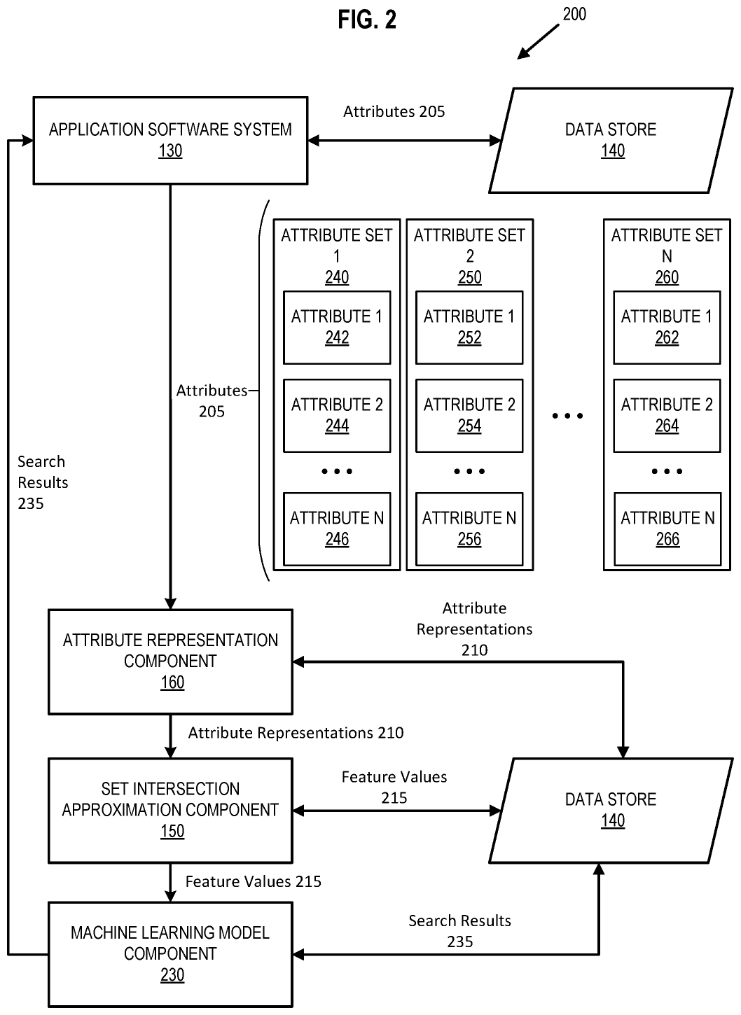

FIG. 2 is a block diagram of an exemplary computing system 200 that includes a set intersection approximation component 150 in accordance with some embodiments of the present disclosure. Exemplary system 200 includes application software system 130, data store 140, attribute representation component 160, set intersection approximation component 150, and machine learning model component 230. Exemplary system 200 also includes attributes 205, attribute representations 210, feature values 215, and search results 235.

Attribute representation component 160 receives attributes 205 from application software system 130. Attributes 205 include multiple attribute sets, attribute set 1 240, attribute set 2 250, and attribute set N 260. As is implied by the variable N, attribute representation component 160 can receive any number of attribute sets. Although more than two attribute sets are shown, in some embodiments attribute representation component 160 only receives two attribute sets. Each of attribute sets 1, and 2 through N 240, 250, and 260 are composed of attributes. For example, attribute set 1 240 contains attributes 1 242 and attributes 2 244 through N 246. As is implied by the variable N, attribute set 1 240 can be composed of any number of attributes. Although more than two attributes are shown, in some embodiments, attribute set 1 240 is only composed of two attributes. Attribute set 2 250 is composed of attribute 1 252 and attributes 2 254 through N 256. Like attribute set 1 240, attribute set 2 250 is composed of at least two attributes. Attribute set N 260 is composed of attribute 1 262 and attributes 2 264 through N 266. Like attribute sets 1 240 and 2 250, attribute set N 260 is composed of at least two attributes.

Each of the attributes in attribute set 1 240 and attribute sets 2 250 through N 260, is a representation of one or more categories, identifiers, characteristics, and/or interests. For example, in a professional social network application, examples of attributes include data associated with a job posting, such as an entity associated with the job posting, a title of the job that is the subject of the job posting, a geographic location of the job, skills relating to the job, an industry associated with the job, and combinations of the foregoing. In other examples in more general social graph applications, attributes include interests associated with a user, such as a sport, hobby, product, event, etc. In some embodiments, attributes are determined through machine learning methods and may be abstract representations (e.g., vector representations or embeddings) of certain characteristics or interests of a user. Each of the attribute sets 240, 250, and 260 are therefore a combination of representations of categories, identifiers, characteristics, and interests. In some embodiments, such as a use in a general social graph application, an attribute set corresponds with a user of the social graph application. For example, each attribute is a representation of a certain characteristic or interest of a user and the set of these attributes represent a stored representation of the characteristics or interests of the user. In some embodiments, the set of attributes is the result of a search query, such as a search result. In some embodiments, the set of attributes is the output of a predictive model, such as a predicted next action of the user. In some embodiments, the set of attributes is a set of observed characteristics, such as a compilation of user activity.

Attribute representation component 160 creates a representation of attributes 205 received from application software system 130. For example, attribute representation component 160 creates a set vector representation for each attribute set in attributes 205. Each attribute set 240, 250, and 260 is therefore converted into a set vector representation with each element of the set vector representation corresponding to an attribute from the attribute set. In some embodiments, each attribute is represented by a random normal vector with a length of 1 and the set vector representation of the attribute set is a set vector composed of the random normal vectors corresponding with the attributes in that attribute set. Therefore, attribute set 1 240 may be represented by set vector a, where set vector a is composed of random normal vectors corresponding to attribute 1 242 and attribute 2 244 through attribute N 246, respectively.

In some embodiments with multisets, the random normal vector corresponding to a duplicate attribute is added to the set vector the same number of times as the duplication. For example, if attribute 1 242 occurs three times within attribute set 1 240, the corresponding random normal vector in set vector a will have a multiset coefficient of 3. In embodiments using multisets, attribute duplications may also occur in non-integer format. For example, attribute 2 244 of attribute set 1 240 represents a social graph application user's interest in tennis. This attribute may be duplicated based on a number of times the user has interacted with media content relating to tennis and based on the level of interaction. In such an example, a like constitutes an interest level of 0.5, a comment constitutes an interest level of 1, and a share constitute an interest level of 1.2. Attribute 2 244 therefore, is duplicated a non-integer number of times such as 2.7 (representing a share, a comment, and a like). In such an example, the corresponding random normal vector in set vector a will have a multiset coefficient of 2.7. Additionally or alternatively, multiset coefficients are used to represent uncertainty in an attribute. For example, attribute N 246 represents living in Washington DC. In some embodiments, attribute N 246 is an output of or a result of application of a predictive model and is associated with an uncertainty from the predictive model. For example, attribute N 246 is an embedding output from a predictive model with an associated uncertainty. In other embodiments, attribute N 246 is based on observed data indicating multiple places for living therefore corresponding with an uncertainty based on the observed data (number of observed instances of living in Washington DC divided by total number of observed instances of living anywhere). In either embodiment, the corresponding random normal vector in set vector a will have a multiset coefficient that corresponds with the uncertainty.

Attribute representation component 160 may create random normal vector representations of attributes using a seed, hash, or other mapping function. The same seed or hash is used for the same attribute across attribute sets such that the same attribute in different attribute sets is represented by the same random normal vector (although the coefficient may differ).

In some embodiments, attribute representation component 160 alters an attribute representation after generating the set vector. Attribute representation component 160 may add or subtract a normal random vector from the set representation upon receiving more information relating to the attribute associated with the normal random vector. For example, attribute representation component 160 receives information indicating that the user associated with attribute set 1 240 has liked additional content relating to tennis. Attribute representation component 160 therefore generates a random normal vector representation using a hash or seed indicating tennis affinity. Attribute representation component 160 assigns a multiset coefficient of 0.5 based on the level of interaction and adds the random normal vector representation with the multiset coefficient to set vector a. In another example, attribute representation component 160 receives information indicating that the user associated with attribute set 1 240 has disliked or otherwise negatively interacted with additional content relating to tennis. Attribute representation component 160 therefore generates a random normal vector representation using a hash or seed indicating tennis affinity. Attribute representation component 160 assigns a multiset coefficient based on the level of interaction and subtracts the random normal vector representation with the multiset coefficient from set vector a. Set vectors associated with attribute sets are therefore able to be easily updated simply by adding or subtracting random normal vectors associated with attributes.

Attribute representation component 160 sends or otherwise provides attribute representations 210 (set vectors) to set intersection approximation component 150. Attribute representation component 160 may also store attribute representations 210 in data store 140 for future access. For example, a certain set that is frequently used in set intersection approximation is stored in data store 140 to speed up computational time required.

Set intersection approximation component 150 approximates a cardinality of a set intersection of the two or more attribute sets 240, 250, and 260. For example, set intersection approximation component 150 approximates the cardinality of the intersection of attribute set 1 240 and attribute set 2 250 using the inner product of the corresponding vector representations. With attribute set 1 240 represented by A and attribute set 2 250 represented by B, the following equation is observed: |A∩B|≈a·b where |A∩B| is the cardinality of the intersection of attribute set 1 240 and attribute set 2 250.

In embodiments using only two attribute sets, set intersection approximation component 150 estimates the cardinality of intersection |A∩B| with approximation error of no more than error value £, such the following equation is satisfied with a high probability: |A∩B|−ε\sqrt{|A|·|B|}<(a·b)+ε\sqrt{|A|·|B|}, where \sqrt{|A|·|B|} is the geometric mean of |A| and |B|. For example, if |A|=|B| and error value 6=0.05, set intersection approximation component 150 estimates the set intersection |A∩B| within 5% of its true value.

In some embodiments, set intersection approximation component 150 approximates the cardinality of the set intersections for more than attribute sets. For example, where attribute set 1 240 is represented by A with corresponding set vector a, attribute set 2 250 is represented by B with corresponding set vector b, and attribute set N 260 is represented by N with corresponding set vector n, set intersection approximation component 150 approximates the cardinality of the intersection |A∩B∩N|. For example, since |A∩B∩N|=|A∪B∪N|−|A|−|B|−|N|+|A∩B|+|A∩N|+|B∩N|, set approximation component 150 calculates the cardinality of the intersection of three sets using the cardinality of the individual sets, the cardinality of the union of the sets, and the cardinality of the set intersections of each pair of the sets. In embodiments using multisets, |A∪B∪N| is the sum of the cardinalities of the individual sets, and set approximation component 150 approximates the cardinality of set intersection |A∩B∩N| using the dot products of each pair of set vectors according to the following equation: |A∩B∩N|≈a·b+a·n+b·n. In embodiments where multisets are not used, set approximation component 150 approximates the cardinality of union |A∩B∩N| and determines the cardinality of set intersection accordingly. For example, set approximation component 150 uses HyperLogLog or a similar algorithm to approximate the cardinality of union |A∩B∩N|. In some embodiments, set approximation component 150 calculates the exact cardinality of union |A∩B∩N| rather than approximating. The number of dimensions, d required to make the approximation with an error factor of no more than ε and with

$$z = {Φ}^{- 1} ( \frac{p + 1}{2} )$$

where p is the probability that the approximation is within the error bound z is represented by the equation

$$d \approx \frac{{z}^{2}}{{ε}^{2}} .$$

The approximation can be verified to be within the error bound by knowing the dimensionality. Because of this relationship between dimensionality d and error factor £, the error factor becomes smaller and smaller the larger the dimensionality. The error factor, therefore, becomes increasingly negligible for larger set sizes.

Set intersection approximation component 150 determines or generates feature values 215 and sends feature values 215 to machine learning model component 230. Set intersection approximation component 150 may also store feature values 215 in data store 140 for future access. For example, a set approximation component 150 uses the cardinality of the set intersection as a feature value. In some embodiments, feature values 215 include the cardinality of the set intersection produced by the set intersection approximation as well as the set vectors. In other embodiments, feature values 215 include the cardinality of the set intersection as well as the attribute sets themselves.

In some embodiments, set intersection approximation component 150 determines feature values 215 for a ranking model based on the cardinality of the set intersection, which set intersection approximation component 150 has determined using the processes described above. For example, set intersection approximation component 150 uses the cardinalities of the set intersections of a search attribute set and multiple result attribute sets as feature values 215 provided to a ranking model to generate a ranking of search results 235. Set intersection approximation component 150 sends feature values 215 to machine learning model component 230. Machine learning model component 230 uses, for example, a ranking machine learning model trained on feature values 215 to rank search results 235. After training by machine learning model component 230, in operation, the trained machine learning model sends search results 235 to application software system 130 for display to a user of the user or otherwise for internal processing. Machine learning model component 230 may also store search results 235 in data store 140 for future access.

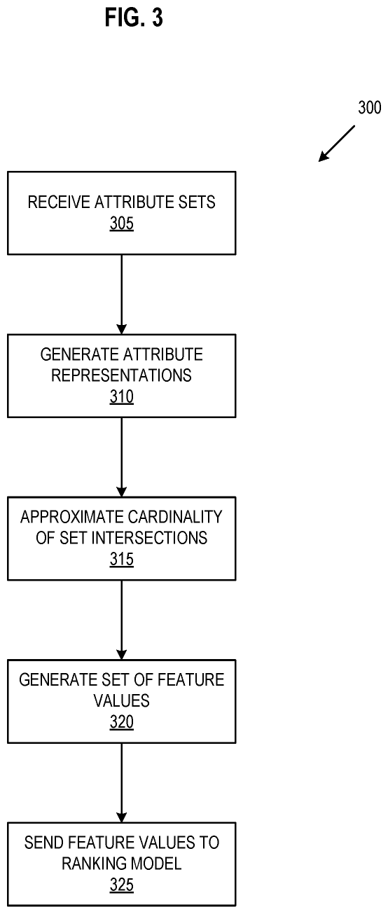

FIG. 3 is a flow diagram of an example method 300 to approximate set intersections using attribute representations, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the set intersection approximation component 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the processing device receives attribute sets. For example, attribute representation component 160 receives attribute sets, such as attribute sets 240, 250, and 260 of FIG. 2, from a data store, such as 140, or application software system, such as 130. The processing device may receive the attribute sets in response to a query or another user action requiring set intersection approximation. For example, a user submits a search query to the application software system and the application software system sends the processing device attribute sets based on the search query.

At operation 310, the processing device generates attribute representations. For example, attribute representation component 160 generates attribute representations of the attributes included in the received attribute sets. In some embodiments, as explained above, the processing device generates attribute representation using random normalized vectors generated using a seed or hash. In some embodiments, the processing device also generate multiset coefficients for the random normalized vectors based on a duplication of attributes associated with the random normalized vector within the received attribute sets. In some embodiments, the processing device also generates multiset coefficients based on an uncertainty corresponding to an attribute.

At operation 315, the processing device approximates the cardinality of set intersections using the attribute representations. For example, set intersection approximation component 150 approximates the cardinality of the set intersection for the received attribute sets using set vectors corresponding with the received attribute sets. Each of the set vectors are composed of the vector representations for attributes associated with each of the received attribute sets. In embodiments with two attribute sets, as explained above, the processing device approximates the cardinality of set intersections using the inner product of the set vectors corresponding with the attribute sets. In embodiments with more than two attribute sets, the processive device approximates the cardinality of set intersections according to methods described above. For example, for embodiments with multisets or sets where the cardinality of the union of the attributes sets is computable, the processing device calculates the cardinality of the set intersection using the cardinality of the union, the cardinality of each of the sets, and the inner product of each pair of set vectors corresponding with the attribute sets.

At operation 320, the processing device generates a set of feature values. For example, set intersection approximation component 150 uses the cardinality of the set intersection and the set vectors as inputs to a ranking machine learning model. In some embodiments, the processing device generates the set of feature values in response to a user query. For example, a user of a social graph application submits a query which causes the processing device to approximate the cardinality of set intersections for each pairing of the search terms and search results. The processing device then generates feature values for the search terms and search results.

At operation 325, the processing device sends feature values to a ranking model. For example, set intersection approximation component 150 sends generated feature values to machine learning ranking model. In embodiments, involving a query submission, the processing device sends feature values and associated set vectors to a ranking machine learning model which ranks the corresponding search results based on the feature values and set vectors. In some embodiments, the processing device sends the attribute sets with the feature values instead of sending the set vectors.

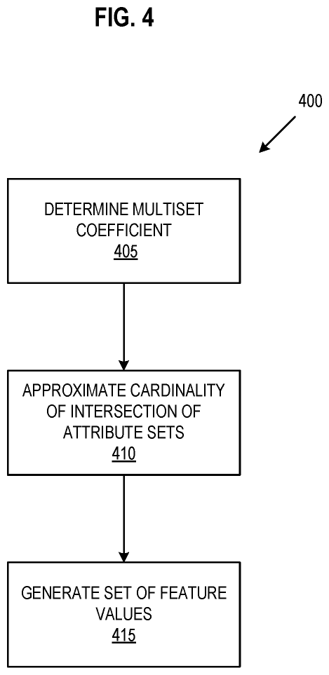

FIG. 4 is a flow diagram of an example method 400 to approximate set intersections using attribute representations, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the set intersection approximation component 150 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 405, the processing device determines a multiset coefficient. For example, attribute representation component 160 generates attribute representations of the attributes included in the received attribute sets using random normalized vectors generated using a seed or hash. In some embodiments, the processing device also generates multiset coefficients for the random normalized vectors based on a duplication of attributes associated with the random normalized vector within the received attribute sets. In some embodiments, the processing device also generates multiset coefficients based on an uncertainty corresponding to an attribute.

At operation 410, the processing device approximates the cardinality of the intersection of the attribute sets. For example, set intersection approximation component 150 approximates the cardinality of the set intersection for the received attribute sets using set vectors corresponding with the received attribute sets. Each of the set vectors are composed of the vector representations for attributes associated with each of the received attribute sets. In embodiments with two attribute sets, as explained above, the processing device approximates the cardinality of set intersections using the inner product of the set vectors corresponding with the attribute sets. In embodiments with more than two attribute sets, the processive device approximates the cardinality of set intersections according to methods described above. For example, for embodiments with multisets or sets where the cardinality of the union of the attributes sets is computable, the processing device calculates the cardinality of the set intersection using the cardinality of the union, the cardinality of each of the sets, and the inner product of each pair of set vectors corresponding with the attribute sets.

At operation 415, the processing device generates a set of feature values. For example, set intersection approximation component 150 uses the cardinality of the set intersection and the set vectors as inputs to a ranking machine learning model. In some embodiments, the processing device generates the set of feature values in response to a user query. For example, a user of a social graph application submits a query which causes the processing device to approximate the cardinality of set intersections for each pairing of the search terms and search results. The processing device then generates feature values for the search terms and search results. In some embodiments, the processing device sends feature values and associated set vectors to a ranking machine learning model which ranks the corresponding search results based on the feature values and set vectors. In some embodiments, the processing device sends the attribute sets with the feature values instead of sending the set vectors.

FIG. 5 illustrates an example machine of a computer system 500 within which a set of instructions, for causing the machine to perform any one or more of the methodologies discussed herein, can be executed. In some embodiments, the computer system 500 can correspond to a component of a networked computer system (e.g., the computer system 100 of FIG. 1) that includes, is coupled to, or utilizes a machine to execute an operating system to perform operations corresponding to the set intersection approximation component 150 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random-access memory (DRAM) such as synchronous DRAM (SDRAM) or Rambus DRAM (RDRAM), etc.), a memory 506 (e.g., flash memory, static random access memory (SRAM), etc.), an input/output system 510, and a data storage system 540, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 512 for performing the operations and steps discussed herein.

The computer system 500 can further include a network interface device 508 to communicate over the network 520. Network interface device 508 can provide a two-way data communication coupling to a network. For example, network interface device 508 can be an integrated-services digital network (ISDN) card, cable modem, satellite modem, or a modem to provide a data communication connection to a corresponding type of telephone line. As another example, network interface device 508 can be a local area network (LAN) card to provide a data communication connection to a compatible LAN. Wireless links can also be implemented. In any such implementation network interface device 508 can send and receives electrical, electromagnetic or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic or optical signals that carry digital data to and from computer system computer system 500.

Computer system 500 can send messages and receive data, including program code, through the network(s) and network interface device 508. In the Internet example, a server can transmit a requested code for an application program through the Internet and network interface device 508. The received code can be executed by processing device 502 as it is received, and/or stored in data storage system 540, or other non-volatile storage for later execution.

The input/output system 510 can include an output device, such as a display, for example a liquid crystal display (LCD) or a touchscreen display, for displaying information to a computer user, or a speaker, a haptic device, or another form of output device. The input/output system 510 can include an input device, for example, alphanumeric keys and other keys configured for communicating information and command selections to processing device 510. An input device can, alternatively or in addition, include a cursor control, such as a mouse, a trackball, or cursor direction keys for communicating direction information and command selections to processing device 510 and for controlling cursor movement on a display. An input device can, alternatively or in addition, include a microphone, a sensor, or an array of sensors, for communicating sensed information to processing device 510. Sensed information can include voice commands, audio signals, geographic location information, and/or digital imagery, for example.

The data storage system 540 can include a machine-readable storage medium 542 (also known as a computer-readable medium) on which is stored one or more sets of instructions 544 or software embodying any one or more of the methodologies or functions described herein. The instructions 544 can also reside, completely or at least partially, within the main memory 504 and/or within the processing device 502 during execution thereof by the computer system 500, the main memory 504 and the processing device 502 also constituting machine-readable storage media.

In one embodiment, the instructions 526 include instructions to implement functionality corresponding to a set intersection approximation component (e.g., the set intersection approximation component 150 of FIG. 1). While the machine-readable storage medium 542 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented methods 300 and 400 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Additionally, as used in this disclosure, the example “at least one of an A, a B, or a C” is intended to cover any of the following selections: {A}, {B}, {C}, {A, B}, {A, C}, {B, C}, and {A, B, C}.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

An example 1 includes generating an approximation of an intersection of attribute sets using set vectors, generating a set of feature values using the approximation, and training a machine learning model using the set of feature values.

An example 2 includes the subject matter of example 1, further including executing a query and determining the plurality of attribute sets based on the execution of the query. An example 3 includes the subject matter of examples 1 and 2 where the query is a job posting query and where determining the plurality of attribute sets further includes: determining a plurality of query results of the job posting query, where a query result of the plurality of query results is associated with an attribute set of the plurality of attribute sets and where the example further includes ranking, by the trained machine learning model, the plurality of query results. An example 4 includes the subject matter of any of examples 1-3, where the generating the approximation includes determining the plurality of attribute sets, where the attribute set includes two or more of: entity, title, location, industry, or skills. An example 5 includes the subject matter of any of examples 1-4, further including determining one or more multiset coefficients, where the one or more multiset coefficients are representations of specific attributes and a multiset coefficient of the one or more multiset coefficients can be a fractional value and generating the approximation using the one or more multiset coefficients. An example 6 includes the subject matter of any of examples 1-5, where determining the one or more multiset coefficients includes determining the representations of the specific attributes where a specific attribute of the specific attributes includes at least one of: entity, title, location, industry, or skills. An example 7 includes the subject matter of any of examples 5 and 6, where determining the multiset coefficient further includes: determining a duplication value for a specific attribute of the specific attributes and determining the multiset coefficient based on the duplication value. An example 8 includes the subject matter of any of examples 5-7, where determining the multiset coefficient further includes: determining an uncertainty value for a specific attribute of the specific attributes and determining the multiset coefficient based on the uncertainty value, where the uncertainty value can be the fractional value An example 9 includes the subject matter of example 8, where determining the uncertainty value includes determining the uncertainty value using attribute data associated with the specific attribute, where the attribute data includes conflicting values for the specific attribute. An example 10 includes the subject matter of any of examples 8 and 9, where determining the uncertainty value includes determining the uncertainty value using an uncertainty output of a predicted model, where the uncertainty output is associated with the specific attribute. An example 11 includes the subject matter of any of examples 5-10, further including generating the plurality of set vectors, where the set vector of the plurality of set vectors is generated using the attribute set of the plurality of attribute sets and a multiset coefficient of the one or more multiset coefficients. An example 12 includes the subject matter of example 11, further including generating a plurality of attribute representations using a plurality of attributes, where the plurality of attributes includes the specific attributes, determining the one or more multiset coefficients is based on the generating the plurality of attribute representations, and the generating the plurality of set vectors further uses the plurality of attribute representations. An example 13 includes the subject matter of example 12, where the plurality of attribute representations includes a plurality of normalized vectors and generating the plurality of attribute representations further includes generating the plurality of normalized vectors using the plurality of attributes and the one or more multiset coefficients. An example 14 includes the subject matter of example 13, where approximating the intersection further uses an approximation of a union of the plurality of attribute sets.

An example 15 includes a system for training a machine learning model for ranking including at least one memory device and at least one processor; and a processing device, operatively coupled with the at least one memory device, to generate an approximation of an intersection of attribute sets using set vectors, where a set vector of the plurality of set vectors is based on an attribute set of the plurality of attribute sets, and an inner product of the plurality of set vectors, generate a set of feature values using the approximation, and train a machine learning model using the set of feature values.

An example 16 includes the subject matter of example 15, where the processing device is further to execute a query and determine the plurality of attribute sets based on the execution of the query. An example 17 includes the subject matter of example 16, where the query is a job posting query and where the processing device is further to determine a plurality of query results of the job posting query, where a query result of the plurality of query results is associated with an attribute set of the plurality of attribute sets and rank, by the trained machine learning model, the plurality of query results. An example 18 includes the subject matter of any of examples 15-17 where the processing device is further to determine the plurality of attribute sets, where the attribute set includes two or more of: entity, title, location, industry, or skills. An example 19 includes the subject matter of any of examples 15-18 where the processing device is further to determine one or more multiset coefficients, where the one or more multiset coefficients are representations of specific attributes and a multiset coefficient of the one or more multiset coefficients can be a fractional value and generate the approximation using the one or more multiset coefficients. An example 20 includes the subject matter of example 19, where the processing device is further to determine the representations of the specific attributes where a specific attribute of the specific attributes includes at least one of: entity, title, location, industry, or skills

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method for training a machine learning model for ranking, the method comprising:
generating an approximation of an intersection of a plurality of attribute sets using a plurality of set vectors, wherein a set vector of the plurality of set vectors is based on an attribute set of the plurality of attribute sets, and an inner product of the plurality of set vectors;
generating a set of feature values using the approximation; and
training the machine learning model using the set of feature values.

2. The method of claim 1, further comprising:
executing a query; and
determining the plurality of attribute sets based on the execution of the query.

3. The method of claim 2, wherein the query is a job posting query and wherein determining the plurality of attribute sets further comprises:
determining a plurality of query results of the job posting query, wherein a query result of the plurality of query results is associated with an attribute set of the plurality of attribute sets and wherein the method further comprises:
ranking, by the trained machine learning model, the plurality of query results.

4. The method of claim 1, wherein the generating the approximation comprises:
determining the plurality of attribute sets, wherein the attribute set comprises two or more of: entity, title, location, industry, or skills.

5. The method of claim 1, further comprising:
determining one or more multiset coefficients, wherein the one or more multiset coefficients are representations of specific attributes and a multiset coefficient of the one or more multiset coefficients can be a fractional value; and
generating the approximation using the one or more multiset coefficients.

6. The method of claim 5, wherein determining the one or more multiset coefficients comprises:
determining the representations of the specific attributes wherein a specific attribute of the specific attributes comprises at least one of: entity, title, location, industry, or skills.

7. The method of claim 5, wherein determining the multiset coefficient further comprises:
determining a duplication value for a specific attribute of the specific attributes; and
determining the multiset coefficient based on the duplication value.

8. The method of claim 5, wherein determining the multiset coefficient further comprises:
determining an uncertainty value for a specific attribute of the specific attributes; and
determining the multiset coefficient based on the uncertainty value, wherein the uncertainty value can be the fractional value.

9. The method of claim 8, wherein determining the uncertainty value comprises:
determining the uncertainty value using attribute data associated with the specific attribute, wherein the attribute data includes conflicting values for the specific attribute.

10. The method of claim 8, wherein determining the uncertainty value comprises:
determining the uncertainty value using an uncertainty output of a predicted model, wherein the uncertainty output is associated with the specific attribute.

11. The method of claim 5, further comprising:
generating the plurality of set vectors, wherein the set vector of the plurality of set vectors is generated using the attribute set of the plurality of attribute sets and a multiset coefficient of the one or more multiset coefficients.

12. The method of claim 11, further comprising:
generating a plurality of attribute representations using a plurality of attributes, wherein the plurality of attributes includes the specific attributes, determining the one or more multiset coefficients is based on the generating the plurality of attribute representations, and the generating the plurality of set vectors further uses the plurality of attribute representations.

13. The method of claim 12, wherein the plurality of attribute representations comprises a plurality of normalized vectors and generating the plurality of attribute representations further comprises:
generating the plurality of normalized vectors using the plurality of attributes and the one or more multiset coefficients.

14. The method of claim 13, wherein approximating the intersection further uses an approximation of a union of the plurality of attribute sets.

15. A system for training a machine learning model for ranking, the system comprising:
at least one memory device; and
a processing device, operatively coupled with the at least one memory device, to:
generate an approximation of an intersection of a plurality of attribute sets using a plurality of set vectors, wherein a set vector of the plurality of set vectors is based on an attribute set of the plurality of attribute sets, and an inner product of the plurality of set vectors;
generate a set of feature values using the approximation; and
train the machine learning model using the set of feature values.

16. The system of claim 15, wherein the processing device is further to:
execute a query; and
determine the plurality of attribute sets based on the execution of the query.

17. The system of claim 16, wherein the query is a job posting query and wherein the processing device is further to:
determine a plurality of query results of the job posting query, wherein a query result of the plurality of query results is associated with an attribute set of the plurality of attribute sets; and
rank, by the trained machine learning model, the plurality of query results.

18. The system of claim 15, wherein the processing device is further to:
determine the plurality of attribute sets, wherein the attribute set comprises two or more of:
entity, title, location, industry, or skills.

19. The system of claim 15, wherein the processing device is further to:
determine one or more multiset coefficients, wherein the one or more multiset coefficients are representations of specific attributes and a multiset coefficient of the one or more multiset coefficients can be a fractional value; and
generate the approximation using the one or more multiset coefficients.

20. The system of claim 19, where the processing device is further to:
determine the representations of the specific attributes wherein a specific attribute of the specific attributes comprises at least one of: entity, title, location, industry, or skills.
